(19) United States
(12) Patent Application Publication
(10) Pub. No.: US 2025/0362726 A1
(43) Pub. Date: Nov. 27, 2025

(54) Improvements to a Portable Power Supply Apparatus

(71) Applicant: Southgate Global Limited, King's Lynn, Norfolk (GB)

(72) Inventors: Charles McIntyre, King's Lynn, Norfolk (GB); David Austin, King's Lynn, Norfolk (GB)

(21) Appl. No.: 18/998,600

(22) PCT Filed: Oct. 3, 2022
(86) PCT No.: PCT/GB2022/052496

§ 371 Date: Jan. 27, 2025

(30) Foreign Application Priority Data
Jul. 26, 2022 (GB) 2210899.7

(51) Int. Cl. G06F 1/26; G06F 1/16; G06F 1/18

(52) U.S. Cl. CPC G06F 1/263; G06F 1/1635; G06F 1/189

(57) ABSTRACT

The invention provides apparatus which can be used to provide electrical power and/or data to one or more items of electrical apparatus from power cells provided as part of a battery unit located in a housing along with a power supply hub to which the electrical items can be selectively electrically connected to be operatable. The apparatus includes a frame which supports the housing and also includes means such as wheels to allow the apparatus to be moved to a location for use and allow the apparatus, and items connected thereto, to be operated independently and remotely from a mains or cable connection to a mains power supply.

The invention to which this application relates is to apparatus of a type which can be used to provide a power supply to one or more electrical items in order to allow the operation of the same. Furthermore, the apparatus, in accordance with one embodiment, includes a portable workstation incorporating one or more areas for selective location and use of said one or more electrical items which are provided with power and/or data from the apparatus.

In one embodiment the one or more electrical items are provided for user interaction therewith to allow the performance of one or more tasks and the electrical items may be, for example, a PC computer system incorporating a memory, processing unit, keyboard and display screen with which a user can interact when power is supplied to the apparatus, a tablet device, printer or such like.

The use of electrical items of the type described above is well-known and typically, the apparatus is provided in one of two formats, a first format, commonly referred to as a desktop format, in which the PC, display screen, keyboard and printer are mounted on a fixed desk unit adjacent to a mains AC power supply to which the same are connected via cables and plugs and sockets provided in the wall of the room in which the desk unit is located. This form of electrical item requires the user to go to the fixed location of the electrical items in order to use the same and this format of electrical item does tend to have a relatively higher processing capability.

An alternative format of electrical items are those which are commonly known as portable devices such as a laptop or tablet device which typically includes an integral display screen and means to allow a touchscreen operation of the same. Alternatively, a laptop device will typically comprise a display screen and a keyboard which are hingedly or slidably connected to each other. The advantage of this form of electrical item is that the same is relatively portable but it is found that in many cases, the processing capacity is relatively limited and interconnectivity with other electrical items such as printers and/or remote devices is limited and/or the electrical item may be susceptible to damage so that, for example, the apparatus is regarded as not being suitable for commercial or industrial usage. Also, the battery life of the portable electrical items tends to be limited so that the same need to be charged at frequent intervals. In many commercial and industrial environments therefore it is found that the commonly available electrical items, in either desktop or laptop format, is not completely functional and/or cannot perform specific tasks at required locations.

For example, in a warehouse environment, there can be a need for an operator to be able to use electrical items at different locations for a period of time, such as locations at which goods are being despatched or stored, and there is a physical requirement for the user to be located at that point for that period of time. There is also a requirement for the operator to be able to use electrical items which have a relatively high level of functionality which may mean that more limited electrical items such as those in a tablet or laptop form, is not appropriate, either due to the lack of processing or battery power and/or the inability, or time required, to interconnect various peripheral devices to the processing electrical item.

Attempts have been made to overcome these problems by providing a portable power supply device which includes a battery unit including one or more power cells therein which provide a DC power supply therefrom and while this may be appropriate for certain electrical items there is often a need to convert the DC power to AC power format and also reconvert the same to DC via an inverter. While this is technically possible, the need for the conversion of the power types renders the conventional apparatus expensive due to the number of conversion components required, bulky and not easily portable and the requirements for these additional components and operation of the same acts as a drain on the one or more power cells which provide the power so that the power cells are required to be connected to a mains power supply and be charged for a considerable period of time and therefore the power cells, and the apparatus as a whole is out of action for significant periods of time. Furthermore, it is found that the life time of the power cells is significantly reduced as a result of the frequency of charging so that the power cells and hence battery unit may have a lifetime of for example 3 years and at which point it is required to be replaced which adds significant expense to the use of the conventional apparatus.

An aim of the present invention is therefore to provide apparatus of a form which allows the same to be provided in a portable format and be available for movement and to provide power for use for a greater proportion of time, thereby allowing the apparatus to be moved to user selected locations for use and thereby allow the user to be able to operate and use their desired electrical items connected to the apparatus at a desired location for a relatively prolonged time. A further aim is to allow the apparatus to be adaptable so as to allow the user to connect and remove said electrical items by using any of a range of connection formats and thereby access the power supply in different formats. A yet further aim is to allow the said power to be available in different formats whilst, at the same time, extending the lifetime of the one or more power cells and battery unit used to provide the power from the apparatus.

In a first aspect of the invention, there is provided portable apparatus for the provision of power therefrom, said apparatus including a housing with a docking station for location of at least one battery unit including one or more power cells from which the power is supplied, and a power supply hub, wherein said power supply hub includes a plurality of power connectors to which one or more electrical items are selectively connected via the appropriate configuration connection means to receive power simultaneously to operate the same and at least one of said power connectors provides power in a DC format and at least one further power connectors provides power in an AC format.

In one embodiment one or more power cells are located in the battery unit and the battery unit is insertable into, and removable from the docking station and, when docked, supply electrical power via electrical connection with the power supply hub. Typically the electrical connection is automatically achieved upon insertion of the battery unit into a correct mechanical location with the docking station.

Typically the apparatus further includes a frame with at least one surface and/or location means for the selective location therewith of the housing and one or more items of apparatus connected to receive power from said power supply hub to allow said electrical items to be operated by a user when located on the frame.

Typically the said electrical items include any, or any combination, of data processing means, user interaction means, a display screen, a printer, a wireless communications hub, a PC, a mobile phone, tablet and may be any form of apparatus which requires power to operate.

In one embodiment the wireless communication hub is provided as an integral part of the power hub.

In one embodiment the wireless communications hub includes a router and/or acts as a wireless signal and/or range booster output device so as to extend or strengthen the wireless signal within the vicinity of the apparatus.

Typically certain of the electrical items may be interconnected to allow the passage of data and/or power therebetween.

In one embodiment said frame includes a plurality of wheels or rollers so as to allow the apparatus to be moved along a support surface, such as the floor of a warehouse, to allow the apparatus to be selectively moved to a desired location for use for a period of time and independently of, and remotely from, any mains power supply or electrical cable connection to the mains power supply of the building in which the apparatus is used.

In one embodiment, the apparatus, and more typically the battery unit, is provided with connection means to allow the same to be connected to a mains power supply to recharge the said power cells and thereby provide the same with a charge to allow operation of the power supply hub of the apparatus independently from the connection with the mains power supply means at the other locations. Alternatively, the said battery unit can be removed from the apparatus docking station to be charged and replaced with a battery unit with charged power cells therein so as to allow the apparatus to be available to supply power at one or more selected locations substantially continuously.

In one embodiment, the power supply hub includes any or any combination of UK configuration three point and/or Schuko and/or US format AC power supply sockets to provide effectively a mains power supply to electrical items connected thereto. Typically, in addition, one or more connection sockets are provided to provide DC power at a DC voltage and in one embodiment the one or more connection sockets are provided as USB sockets to supply power at one or more further DC voltage levels.

In one embodiment the control means of the apparatus is adapted with respect to a predetermined geographical location at which the apparatus is to be used so as to ensure that the AC voltage provided by the said power connectors matches that which is required by the apparatus when used at the said geographical location. In one embodiment the adaptation is achieved by selecting to use one or more appropriately rated inverters.

Typically the inverters are provided so as to be relatively easily replaceable, typically as “plug and play” components and thereby allow the adaptation of the voltage configuration of the apparatus output to be changed without whole re-design of the apparatus for use in different geographical locations.

In one embodiment the sockets for the provision of power are provided in groups, with a first group for the provision of DC voltage, a second group for the provision of AC voltage and/or a further group for the provision of different user selectable Voltage levels in a range of voltages.

Typically each group is provided with a user operable on/off switch to enable or disable the provision of power from the respective group of connectors.

Typically the power supply hub is provided integrally with the docking station in the same housing. In one embodiment the electrical connectors provided in the power supply hub may be changed from time to time to allow safe operation and/or a change of format of the connectors to be achieved without requiring replacement of the hub.

In one embodiment the apparatus includes an operational check system to ensure correct connection and operation of at least one part of the apparatus such as the one or more power cells and hence the battery unit, prior to allowing the provision of electrical power from the power supply hub. In addition, or alternatively, the operational check system can receive and make available data relating to the operation of one or more further parts and/or components of the apparatus. In one embodiment the other components include the RCD's and/or inverters.

Typically the data is made available on a live or real time basis and, if necessary, will generate an alarm indication if the data indicates that the status of one or more of the components is malfunctioning and thereby provides the ability for the operator to shut down the system and therefore avoid damage to the same and/or to apparatus which is connected to the same.

In one embodiment short range wireless communication means, such as Bluetooth, is used to allow the transmission of data from components of the apparatus to the operational check system so as to provide an indication of operating performance.

In addition, or alternatively, a long range wireless communication means is provided so as to allow data indicating the performance of the battery unit and/or other components to be transmitted to a control means at the location of use of the apparatus and/or to a remote location so as to allow a service provider of the apparatus to monitor and repair, if required, the apparatus.

In one embodiment the RCD's provided on the said power supply hub are provided in a form such that a visual indication is provided to the user of the apparatus of correct operation status or failure. In one embodiment the RCD's each include a fuse and the fuse is mounted so that failure of the fuse provides the visual indication of the RCD failure.

In one embodiment the apparatus is usable to provide power in AC and DC formats from the power supply hub simultaneously.

Specific embodiments of the invention are now described with reference to the accompanying drawings; wherein

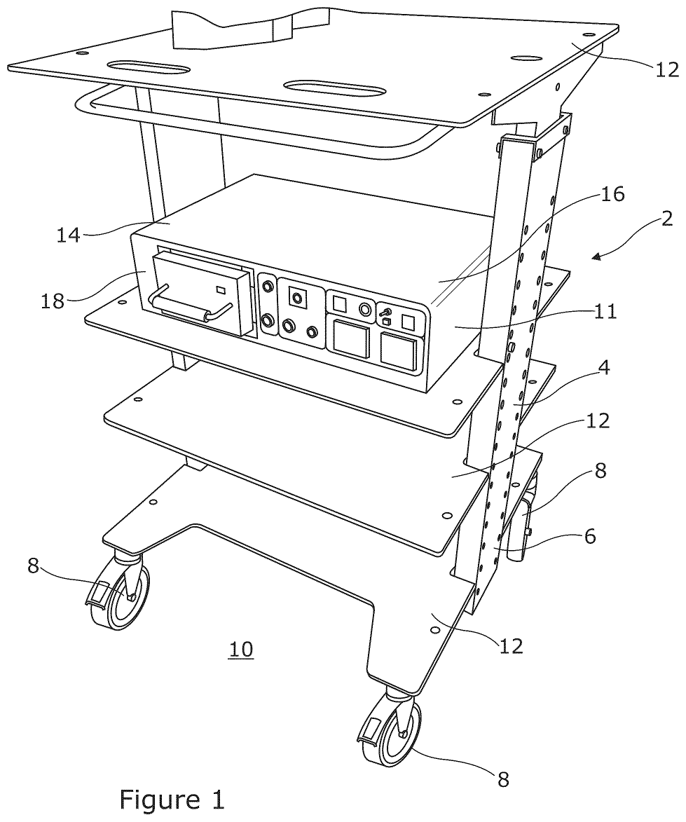

FIG. 1 illustrates a view of one embodiment of apparatus in accordance with the invention;

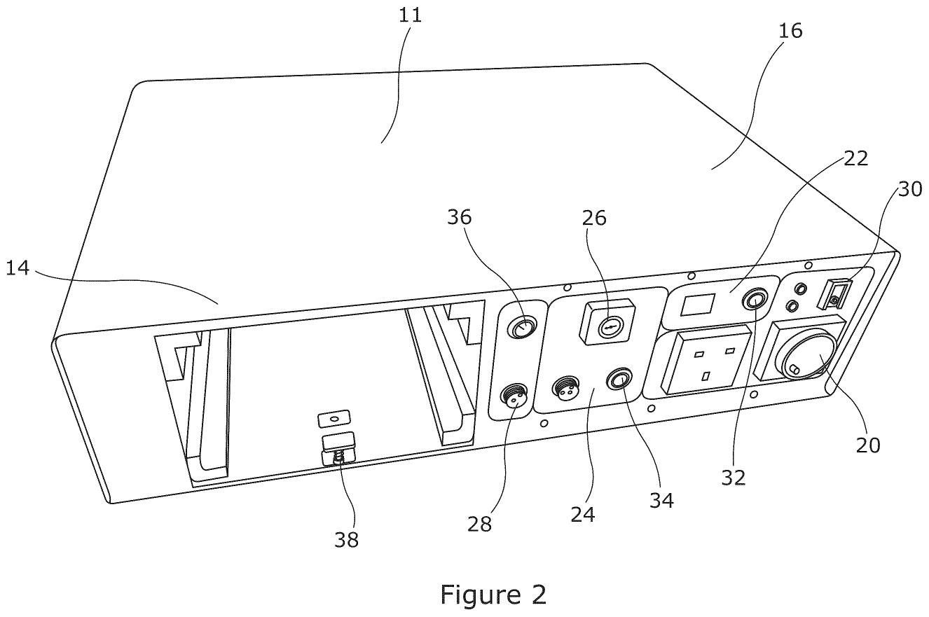

FIG. 2 illustrates the docking station and power supply hub of the apparatus of FIG. 1 in greater detail;

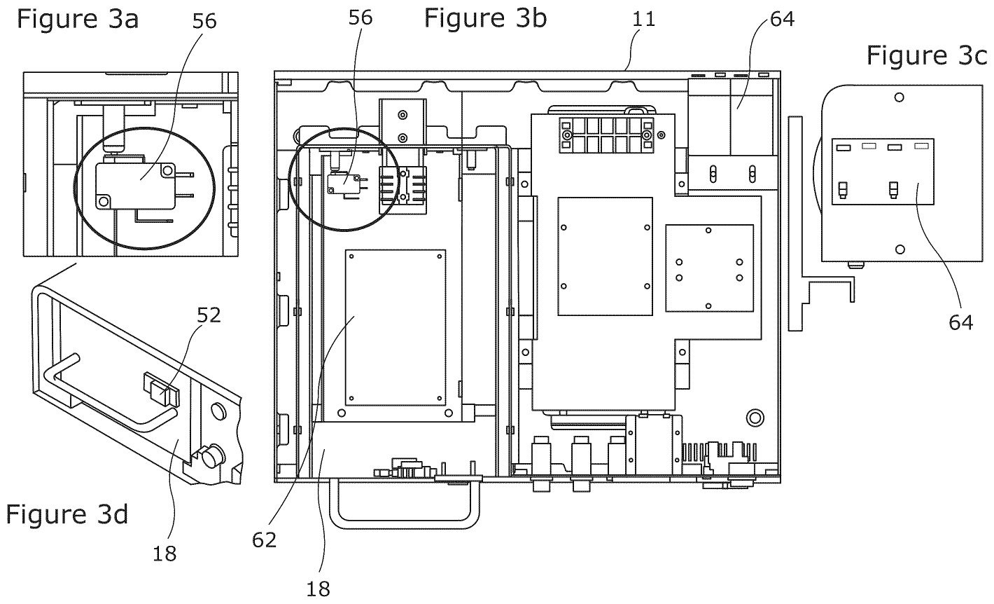

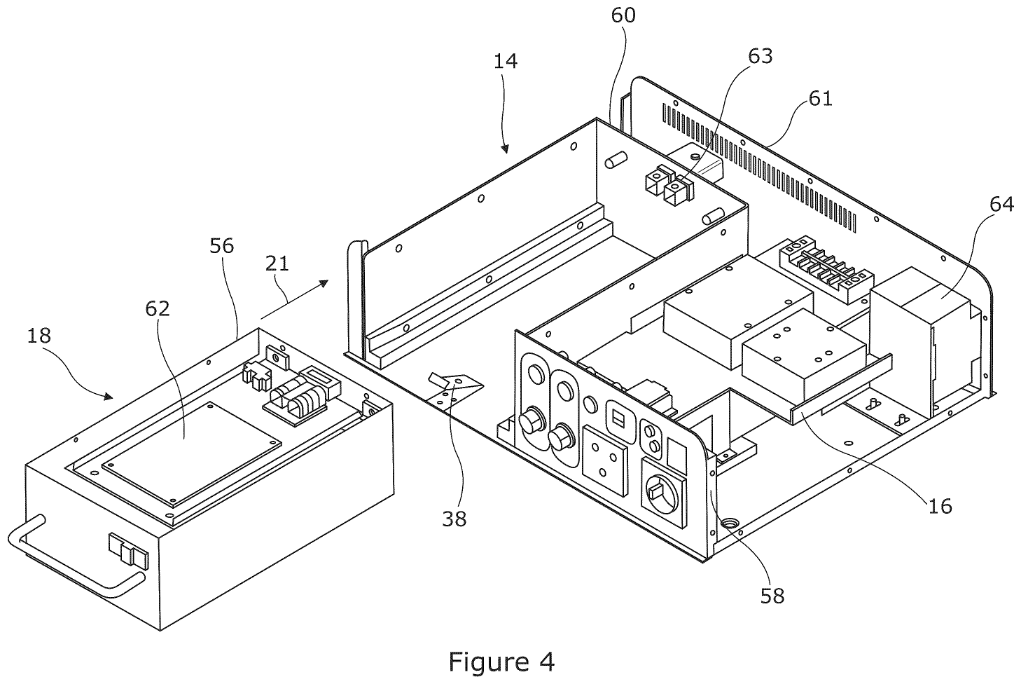

FIGS. 3a-d illustrates a plan view of the interior of the housing of the apparatus and specific features of the apparatus in accordance with one embodiment;

FIG. 4 illustrates a perspective view of the apparatus showing locking means of the docking station;

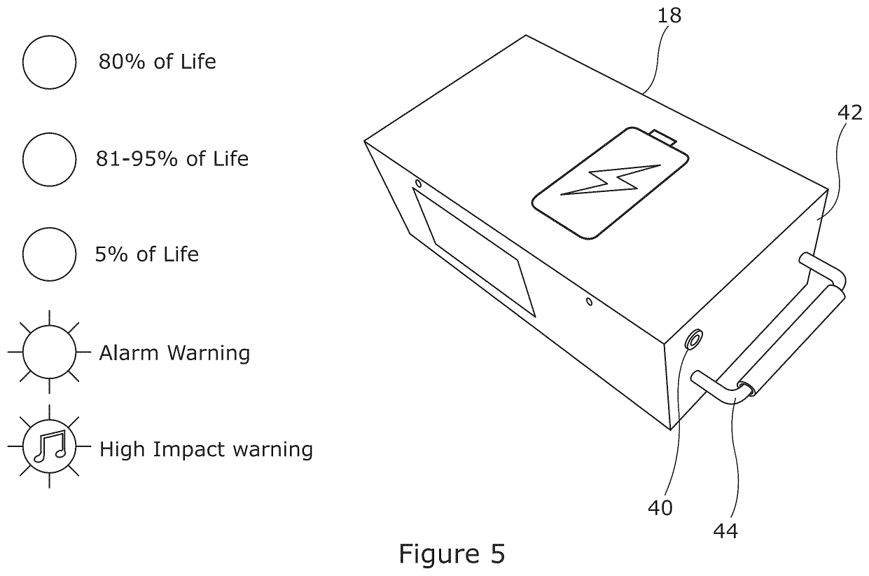

FIG. 5 illustrates a battery unit for use in the docking station of the apparatus;

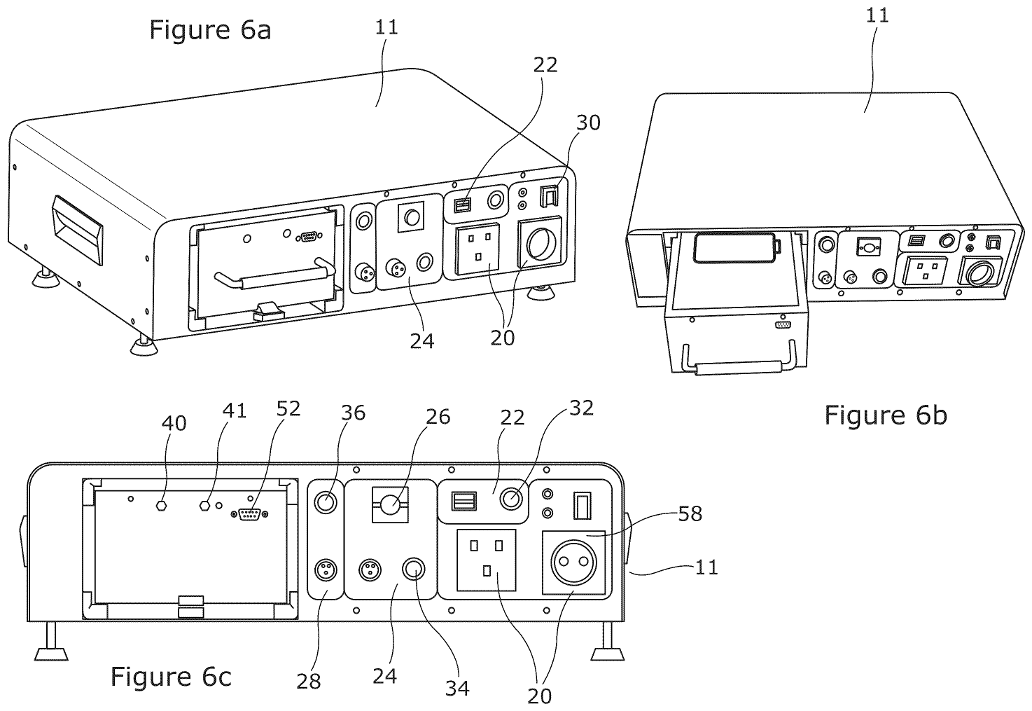

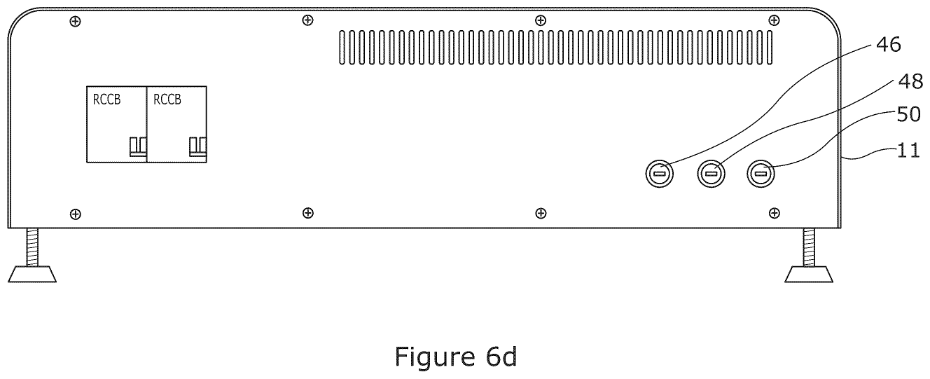

FIGS. 6a-d illustrate views of the external features of the housing in accordance with one embodiment of the invention; and

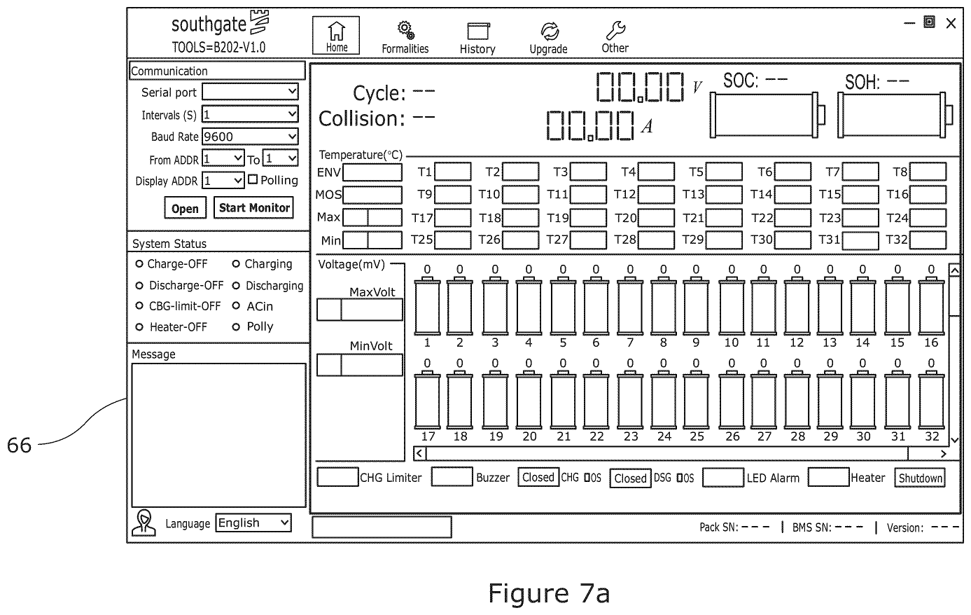

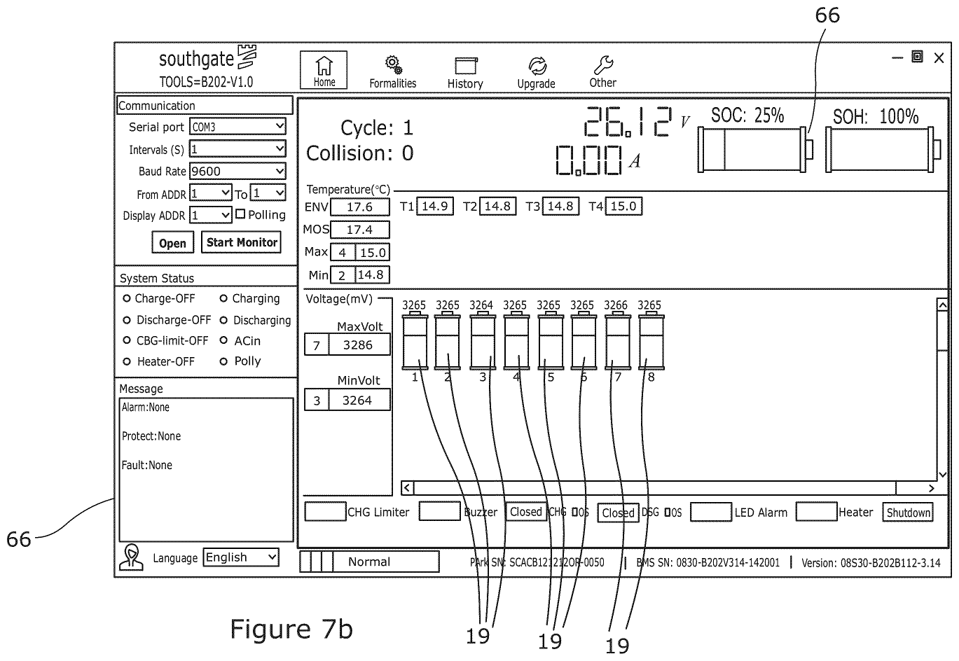

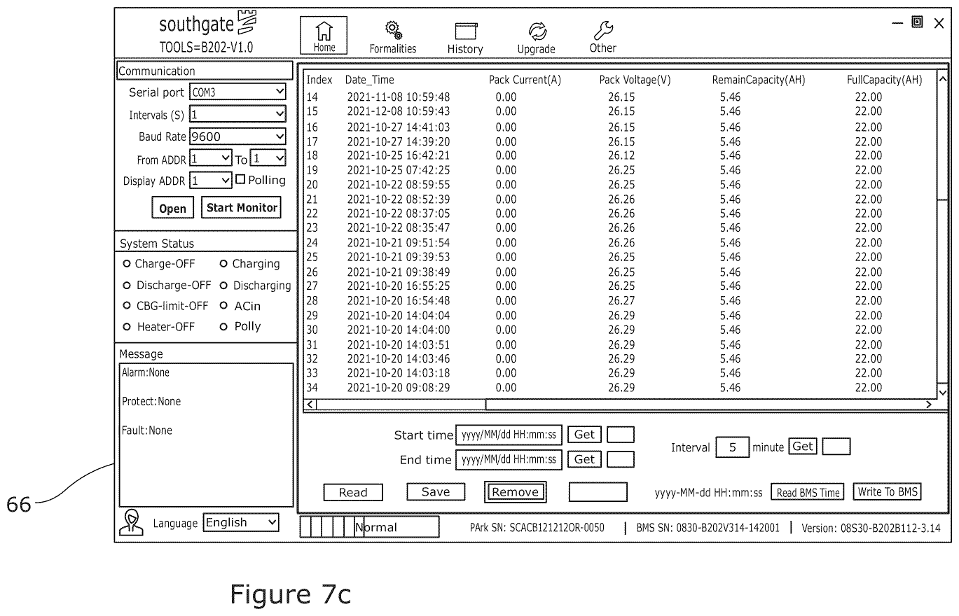

FIGS. 7a-c illustrate a battery monitoring and management display in accordance with one embodiment of the invention.

In accordance with the invention in the embodiment shown in FIGS. 1 and 2, there is provided apparatus 2 in an embodiment which includes a frame 4 which includes thereon a base 6, and wheels 8 at each corner, two of which are shown. The wheels therefore allow the frame and apparatus as a whole to be moved across a surface 10 such as, for example, the floor of a warehouse to locations a t which the apparatus is to be used and without the need for connection to a mains power supply.

The frame also includes a series of spaced apart support surfaces 12 which can be selectively positioned so as to provide one or more surfaces on which electrical items which are to be provided with power from the apparatus, can be placed for use, such as data processing means, scanners, printers, display screens or the like. The apparatus also includes a housing 11 which may be engaged with the frame or placed on one of the support surfaces. Also, it should be noted that the housing, and the contents thereof, can be provided as a separate unit which can be selectively placed at an appropriate location for use independently from the frame. The frame therefore does not need to be part of the apparatus and is optional.

The housing 11 includes a docking station 14 and a power supply and/or data hub 16. Typically, the hub 16 is provided in electrical connection with the power supply provided from the one or more power cells 19 located in a battery unit 18 when the battery unit is mechanically and electrically connected in the docking station 14.

Turning now to FIG. 4, which shows the housing 11 with the top lid removed for ease of reference, the battery unit 18 includes therein the one or more power cells in an enclosed cavity and provides from the power cells 19, in combination, power to operate said electrical items connected to the hub 16 at that time.

The power supply hub 16 is provided with electrical connection means 63 to allow the electrical connection of the battery unit 18, which typically occurs automatically when the battery unit 18 is correctly mechanically and electrically docked into the docking station 14 as indicated by the arrow 21. The battery unit 18 is mechanically retained in position, in this embodiment via engagement with an engagement clip 38, as shown in FIGS. 2 and 4 and the required electrical engagement with electrical connection means socket 63 of the housing is achieved by the location of the battery unit 18 with guide pins 60, 61, one of which, pin 61, also activates a microswitch 56 of the battery unit which automatically changes to an on condition upon correct insertion of the battery unit into the docking station and to an off condition upon removal of the battery unit 18 from the docking station 14. The microswitch location is illustrated in FIGS. 3a-b and 4 with, in FIG. 3a, the battery unit 18 being illustrated as located in the docking station 14. When the battery unit microswitch is moved to the on condition then electrical connection of power from the power cells 19 to the hub 16 is possible within the housing and via electrical connection means 63.

The battery unit 18 is also connectable to a mains power supply, typically when removed from the docking station, so as to allow the power cells 19 in the battery unit 18 to be charged. Sufficient power cells capacity can be provided in the battery unit 18 so that, when fully charged, there is sufficient power supplied to the hub to allow operation of a plurality of electrical items connected thereto and to operate the electrical items, for a number of hours before charging of the power cells 19 of the battery unit 18 is required. The capacity and length of time between charges, can be selected so as to allow the apparatus to be usable, typically, in for example, one or more shifts of employees or operators working in for example, a warehouse. Between charges, the apparatus 2 can be moved to any suitable location for use and the supply of power therefrom and independently from the mains power supply. Furthermore, or alternatively, the battery unit 18 can be removed from the docking station for charging and be immediately replaced by a charged battery unit 18, thereby ensuring that the apparatus is substantially continuously available for use.

The battery unit 18 includes an accelerometer 62 and the hub 16 includes RCD trip switches 64 so that alarms can be generated upon the detected occurrence of certain hazardous operating conditions, such as the occurrence of high charging at low heat, discharging at high levels with low heat, low or over voltage conditions, overcharging conditions, overcurrent conditions and/or impact occurrence on the apparatus and, if necessary, stop operation of the apparatus until the hazard is resolved.

Testing means are provided to allow the power cells condition to be tested, preferably automatically, such as via connection with an RS232 output 52 on the battery unit 18 as shown in FIG. 3d, to ensure that the condition of the battery unit is suitable for use and, if so, then the apparatus is rendered available to use to supply power to the connected electrical items.

As illustrated in FIGS. 5 and 6a-c a visual display is provided on the external face 42 of the battery unit 18 to show the condition of the battery unit 18 at a particular instant of time via, in this embodiment display lights 40, 41 provided on the external face 42 of the battery unit 18. A handle 44 is also provided on the external face 42 to allow the user to easily insert and remove the battery unit into and from the docking station 14. The display lights 40,41 can be caused to illuminate in a number of different ways such that the display lights 41 are controlled such that green lights indicate that the battery unit has 100-80% life remaining, amber lights indicate 81-5% life remaining, and red light less than 5% life remaining. The light source 40 can be controlled to flash red to indicate an operation alarm and to flash red in conjunction with an audible alarm to indicate that there has been an impact on the battery unit 18 or housing 11 generally which may have damaged the same or caused a fault in the electrical connection.

As shown in FIG. 2 and FIGS. 6a-d the hub 16 of the housing includes a DC: AC inverter power switch 58 which is connected to inverters provided within the housing and which allow the supply of power to certain of the electrical supply sockets which are available for the connection of plugs of electrical items which are to be powered so that the appropriate voltage type and level can be supplied. The sockets which are available to be used can be provided in groups, with, in this embodiment, a first group 20 providing AC format power sockets and including, for example, a UK DC: AC socket and a Euro or Schuko DC: AC socket. The group 22 includes a USB-C power socket to provide DC: DC power at a predetermined voltage level, the group 24 allows DC: DC power to be provided at one of a range of user selectable voltage levels via operation of control selector 26 and may include a socket of a different format to the others, and group 28 allows the provision of DC: DC power at a fixed DC voltage level.

In this embodiment, in each group there is provided a switch 30,32,34,36 which allows the control of power from the connectors in each group independently and the provision of power simultaneously from those groups for which the switch for that group is in the on position.

Thus, it will be appreciated that more than one group of connectors can be provided in an on condition simultaneously so as to allow, for example, AC and DC power to be supplied simultaneously to different connected electrical items and hence allow those electrical items which require DC power to be operated at the same time as electrical requiring AC power and from the same hub 16.

The rear of the housing is shown in FIG. 6d and shows the provision of three fuse access and replacement locations 46, 48, 50 to provide protection for the fixed voltage, variable voltage and USB connections of the apparatus.

It is found that the apparatus in accordance with the invention allows the lifetime of the power cells 19 and hence the battery unit 18 to be increased in comparison to when used with conventional apparatus from 3 years to 5 years.

In one embodiment, as illustrated with respect to FIGS. 7a-c, the apparatus includes a battery unit monitoring and management software system which is visually displayed via a display screen 66 to illustrate the charge condition of power cells 19 within the battery unit 18. When the battery unit 18 is not connected to the battery monitoring system the display screen of FIG. 7a is displayed. Once the monitoring system is connected to the battery unit, in one embodiment via the RS232 connector, the display of FIG. 7b will be displayed and will provide a representation of the charge condition of each of the power cells 19 detected as being present in the battery unit 18, and the combined condition 66 of the battery unit. A continual monitoring of the activity, performance and temperature of the power cells and the occurrence of any impacts which may occur on the apparatus is visually displayed as indicated in FIG. 7c.

It should also be appreciated that the electrical connectors provided on the power supply hub may include one or more connectors which allow the provision of wireless charging and operation of suitable adapted items of apparatus such as, for example, via indictive charging and in which case the said area of the apparatus provided for the selective use and location of the electrical items is provided with a surface portion, typically visually indicated, at which the electrical item can be placed to be charged.

There is therefore provided, in accordance with the invention, apparatus which can be used to provide electrical power and/or data to one or more items of electrical apparatus from power cells provided as part of a battery unit located in a housing along with a power supply hub to which the electrical items can be selectively electrically connected to be operable. The apparatus includes a frame which supports the housing and also includes means such as wheels to allow the apparatus to be moved to a location for use and allow the items to be operated independently and remotely from a mains or cable connection to a mains power supply.

1. Portable apparatus for the provision of power therefrom, said apparatus including a housing with a docking station for location of at least one battery unit including one or more power cells from which the power is supplied, and a power supply hub, wherein said power supply hub includes a plurality of power connectors to which one or more electrical items are selectively connected via the appropriate configuration connection means to receive power simultaneously to operate the same and at least one of said power connectors provides power in a DC format and at least one further power connectors provides power in an AC format.

2. Apparatus according to claim 1 wherein one or more power cells are located in the battery unit which is insertable into, and removable from the docking station and, when docked, supplies electrical power via electrical connection with the power supply hub.

3. Apparatus according to claim 2 wherein the said electrical connection is automatically achieved upon insertion of the battery unit into correct mechanical location with the docking station.

4. Apparatus according to claim 1 wherein the apparatus includes a frame with at least one surface and/or location means for the location therewith of the housing and one or more items connected to receive power from said power supply hub to allow said one or more items to be operated when located with the frame.

5. Apparatus according to claim 4 wherein said frame includes a plurality of wheels or rollers so as to allow the apparatus to be moved along a support surface to allow the apparatus to be selectively moved to a desired location for use for a period of time independently of connection to a mains power supply.

6. Apparatus according to claim 4 wherein the said one or more items include any, or any combination, of data processing means, user interaction means, a display screen, a printer, a wireless communications unit, a mobile phone or tablet device.

7. Apparatus according to claim 6 wherein, when provided, the wireless communication unit is provided as an integral part of the power supply hub.

8. Apparatus according to claim 6 wherein the wireless communications unit includes a router and/or acts as a wireless booster output device so as to extend or strengthen the wireless signal within the vicinity of the apparatus.

9. Apparatus according to claim 1 wherein at least some of said one or more electrical items, and/or the power supply hub are interconnected to allow passage of data and/or power therebetween.

10. Apparatus according to claim 1 wherein the said at least one battery unit is provided with connection means to allow the same to be connected to a mains power supply to recharge one or more power cells located in the at least one battery unit to allow operation of the power supply hub of the apparatus independently from a connection with the mains power supply.

11. Apparatus according to claim 10 wherein said battery unit is removed from the said docking station to be charged and replaced with a battery unit with charged power cells therein so as to allow the apparatus to supply power at one or more selected locations for the apparatus substantially continuously.

12. Apparatus according to claim 1 wherein the power supply hub includes any or any combination of UK configuration three point and/or Schuko and/or US format AC power supply sockets to allow supply of AC power to items connected thereto.

13. Apparatus according to claim 1 wherein the power supply hub includes one or more connection sockets to provide DC power at one or more DC voltage levels.

14. Apparatus according to claim 1 wherein a control means for operation of the power supply hub are adapted with respect to a predetermined geographical location at which the apparatus is to be used so as to ensure that the AC voltage level provided by the said plurality of power connectors matches that which is required for safe operation of apparatus at the geographical location.

15. Apparatus according to claim 14 wherein the control means include one or more inverters and the adaptation is to select to use the appropriate one or more inverters.

16. Apparatus according to claim 1 wherein sockets for provision of power are provided in groups with respect to a first group for provision of DC voltage, a second group for provision of AC voltage and/or a further group for provision of power in a range of user selectable Voltage levels.

17. Apparatus according to claim 16 wherein each group is provided with a user operable on/off switch to enable or disable the provision of power from that respective group of connectors.

18. Apparatus according to claim 1 wherein the power supply hub is provided integrally with the docking station in the same housing.

19. Apparatus according to claim 1 wherein the electrical connectors provided in the power supply hub are replaceable to allow safe operation and/or a change of format of the connectors to be achieved without requiring replacement of the power supply hub.

20. Apparatus according to claim 1 wherein the apparatus includes an operational check system to ensure correct connection and operation of at least part of the apparatus.

21. Apparatus according to claim 20 wherein said at least part of the apparatus is the one or more power cells and the battery unit to ensure correct operation prior to allowing the provision of electrical power from the battery unit to the power supply hub.

22. Apparatus according to claim 20 wherein the operational check system can receives and makes available data relating to the operation of one or more parts and/or components of the apparatus.

23. Apparatus according to claim 22 wherein the data is made available on a live basis and, if necessary, used to generate an alarm indication if the data indicates that the status of one or more of the parts and/or components is malfunctioning.

24. Apparatus according to claim 20 wherein short range wireless communication means is used to allow the transmission of data from parts and/or components of the apparatus to the operational check system so as to provide an indication of operating performance.

25. Apparatus according to claim 20 wherein a long range wireless communication means is provided to allow data indicating a performance of the parts and/or components of the apparatus to be transmitted to a control means at the location of use of the apparatus or a remote location to allow a service provider of the apparatus to monitor and repair, if required, the apparatus.

26. Apparatus according to claim 1 wherein one or more RCD's are provided in a form such that a visual indication is provided to a user of the apparatus of failure of the RCD.

27. Apparatus according to claim 1 wherein the apparatus provides power in AC and DC formats from the power supply hub simultaneously.
